(19) United States
(12) Patent Application Publication
(10) Pub. No.: US 2005/0215228 A1
(43) Pub. Date: Sep. 29, 2005

(54) Voice session data session interoperability in the telephony environment

(75) Inventors: Gideon Fostick, Givat Shmuel (IL); Gil Bul, Kadima (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD.

(21) Appl. No.: 10/809,840

(22) Filed: Mar. 26, 2004

(51) Int. Cl. H04L 12/66

(52) U.S. Cl. 455/403

(57) ABSTRACT

Apparatus for initiating a data session at a remote communication unit currently connected via a voice session, includes a cue unit for sending via the voice session to the remote unit a cue decodable as an instruction to start a data session, and an address unit for making data session address information, such as a URL, available to the data session. Thus a user is enabled to connect to a service via standard dialing and yet receive the required service in menu or graphic or other data format.

### FIELD AND BACKGROUND OF THE INVENTION

The present invention relates to interoperability between voice and data sessions in the telephony environment and, more particularly, but not exclusively addresses the difficulty of entering data sessions in the telephony environment as against the suitability of a data session for certain telephony tasks. Increasingly services are offered to subscribers by telephone within a voice session, using Interactive Voice Response (IVR). Such services include e.g. information services, customer care, and sales applications. However, often the service would be more convenient to use with a visual interface rather then a voice interface. The visual interface can typically be provided by a data session, e.g. WAP browsing. The following are examples of services best provided by a data session rather than a voice session:
“Visual Directory Assistance”: the subscriber calls a company by telephone, and needs to find a specific extension. The subscriber would benefit if s/he could browse visually through a list of names.
“Window Shopping”: E.g. purchasing pizza by telephones. Visual browsing would allow the subscriber to choose pizza options from pictures.
“Visual Voicemail deposit”: the subscriber calls the called party but is redirected to voicemail. At this point, instead of just recording a voice message, a visual service could offer the caller additional options, such as typing in a textual message to be sent to the called party.
   On the other hand, voice sessions have a major advantage over data sessions in the ease of initiation. Initiating a voice session merely requires dialing into the service's telephones number. Initiating a data session requires an inconvenient process, primarily manually entering a URL into a telephone interface. Commonly the URL is difficult to remember and additionally it is difficult to enter the URL on the telephone's keypad.

### SUMMARY OF THE INVENTION

According to one embodiment there is provided an apparatus for initiating a data session at a remote communication unit currently connected via a voice session, the apparatus comprising:
a cue unit for sending via the voice session to the remote unit a cue decodable as an instruction to start a data session, and
an address unit for making data session address information available to the data session.

According to a second embodiment there is provided a client for a mobile telephony device, comprising:
a decoder for decoding a received voice session command to transfer to a data session, and
a data session launcher, associated with the decoder, for launching a data session at the mobile telephony device.

According to a third embodiment there is provided a method of launching a data session at a remote telephony device that has connected using a voice session, the method comprising:
issuing a data session launch command via the voice session to the remote telephony device, and
issuing data session address information for use in association with a data session launched in consequence of the command.

In the present disclosure the term “smart telephone”, is used to describe a telephone or mobile handset having sufficient intelligence capacity to run a client program able to carry out the part of a client in the embodiments described herein. Many cellular handsets match this criterion, for example the Nokia 7650 cellular telephone running the Symbian operating system. Moreover, in landline type telephones the DECT cordless telephones often, have such a capability.

Unless otherwise defined, all technical and scientific terms used herein have the same meaning as commonly understood by one of ordinary skill in the art to which this invention belongs. The materials, methods, and examples provided herein are illustrative only and are not intended to be limiting.

It will be noted that certain features of the present embodiments may be implemented by hardware and/or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing the use of a mobile communication device to initiate a standard voice session via dialing a telephone number;

FIG. 2 is a simplified diagram showing a menu of available extensions at a called number, the menu being made available as the result of a data session initiated automatically from the originally dialed voice session according to preferred embodiments;

FIG. 3 is a simplified diagram illustrating the system, including the remotely located handset, that allows services at the called number to be made available via automatically initiated data sessions according to a preferred embodiment;

FIG. 4 is a simplified flow chart illustrating a procedure for automatically initiating a data session according to one preferred embodiment;

FIG. 5 is a simplified flow chart illustrating an alternative procedure for automatically initiating a data session according to another preferred embodiment;

FIG. 6 illustrates a client to be provided at a mobile telephony device for carrying out a voice to data session transfer in accordance with a remotely received voice command in accordance with a preferred embodiment; and

FIG. 7 is a simplified diagram illustrating a control apparatus at an application server for managing remote initiation of a data session in accordance with a preferred embodiment.

### DESCRIPTION OF THE PREFERRED EMBODIMENTS

The present embodiments comprise methods and apparatus for permitting data based telephony services to be accessed after dialing and setting up a standard voice connection. The service is typically provided via a data server, and the data server signals a switch to a data session by issuing a voice cue to an accessing handset over the connection via the voice session. The handset has a client component which recognizes the voice cue and enters a data session. The data session allows the service to be provided in a graphic manner or as menu items as desired.

The principles and operation of voice data interactivity according to the present invention may be better understood with reference to the drawings and accompanying description.

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

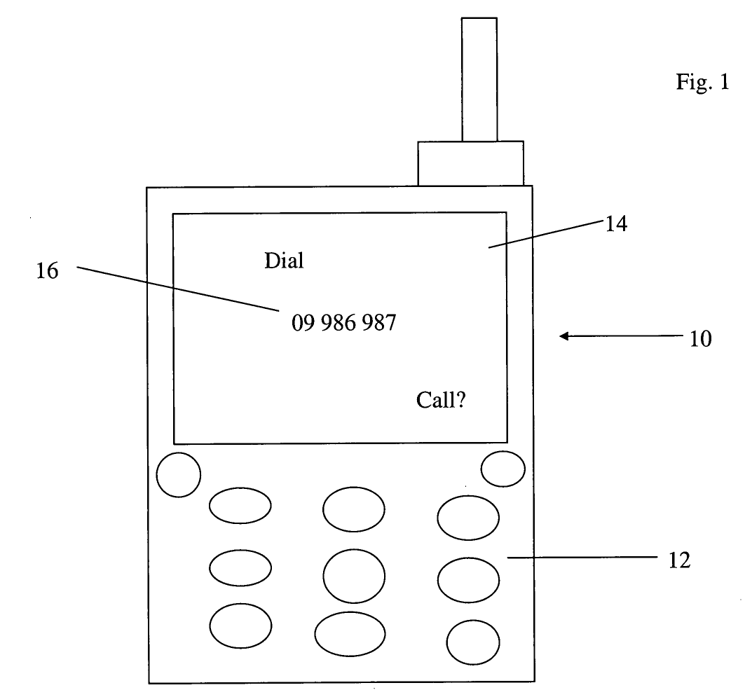

Reference is now made to FIG. 1, which is a simplified diagram showing the use of a mobile communication device to initiate a standard voice session by dialing a telephone number. In FIG. 1 a mobile telephony device 10 comprises a keypad 12 and a screen 14. A telephone number 16 is entered via the keypad and dialed. As a result a regular voice session is set up.

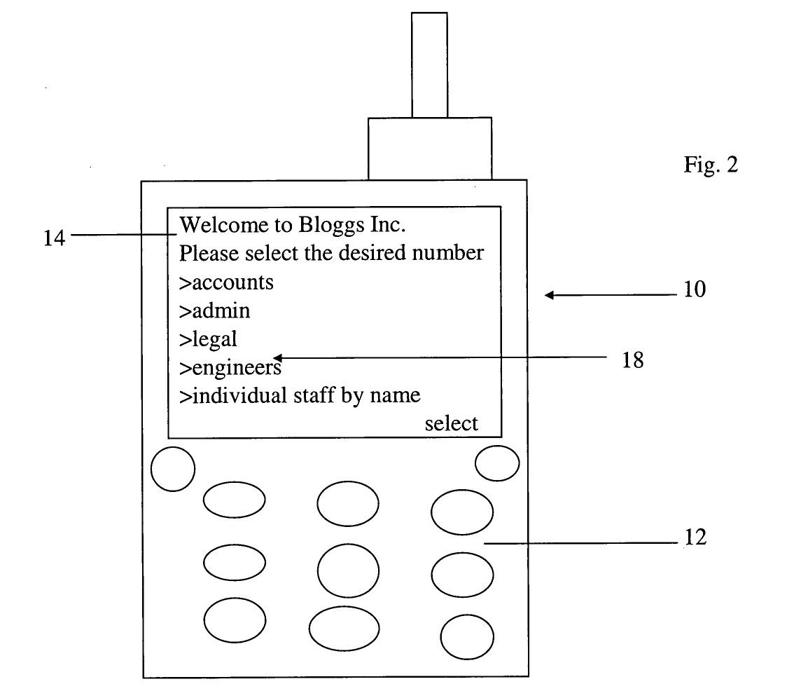

Reference is now made to FIG. 2, which is a simplified diagram showing the mobile communication device of FIG. 1 after the voice session initiated in FIG. 1 has automatically been converted to a data session in accordance with preferred embodiments of the present invention. Parts that are the same as FIG. 1 are given the same reference numerals and are not referred to again except as necessary for understanding the present embodiment. As illustrated the called number is the number of an office having a number of departments and individual user extensions. To date the caller is typically asked, via interactive voice, to enter an extension number if he knows it, dial zero for the operator or wait through an often interminable list until he hears the name of the person or department he intends to call. In the present embodiment however the session is instead changed into a data session, preferably using one of the procedures outlined below. Consequently the available extensions are listed as a menu 18. The menu may be a layered menu listing departments at one level and individual users at a further level. The selection of one of the menu items may lead to an immediate connection to an extension, or may lead to further menus or may lead to information, depending on the particular service being provided. That is to say the service provided by the data session could be any kind of service that it is convenient to provide in this manner, the limitations on the service being only the limitations of the connecting devices and the imaginations of the programmers.

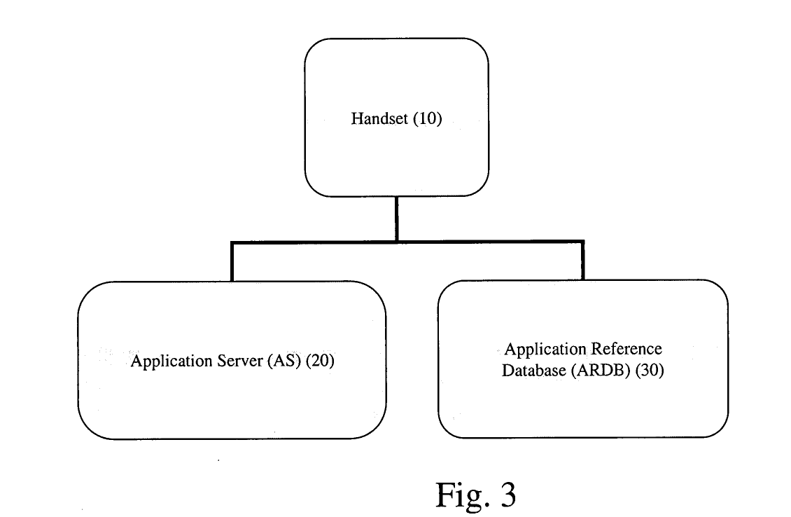

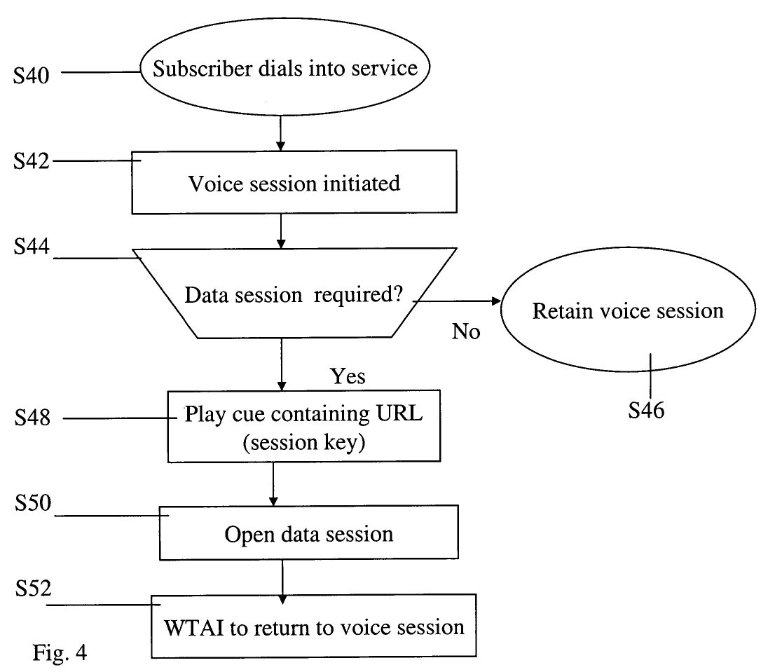

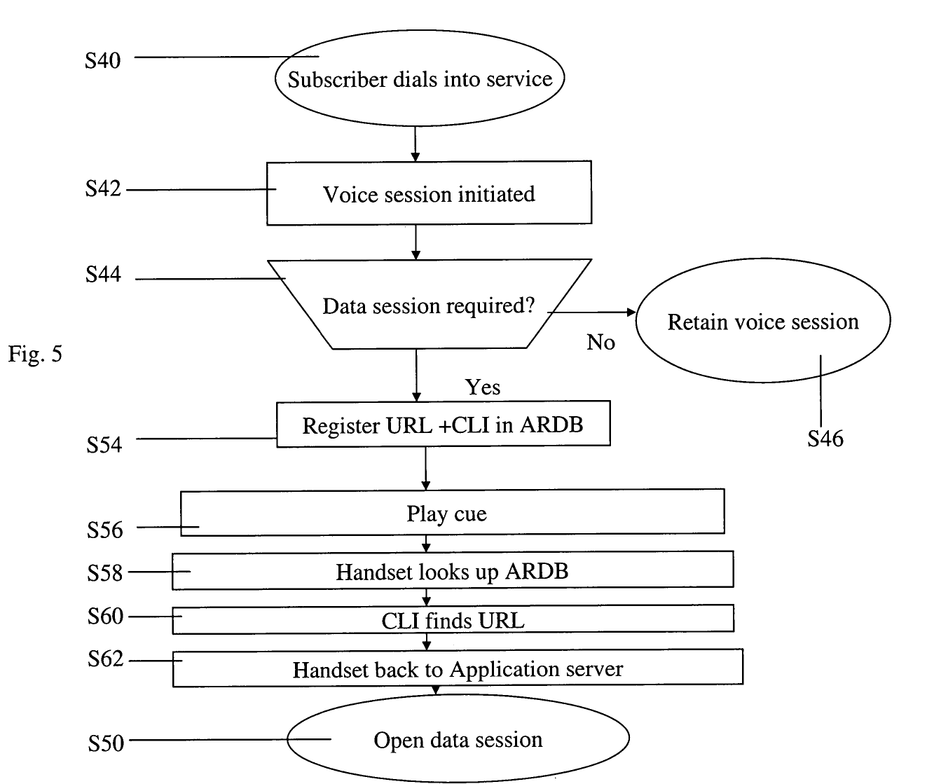

Reference is now made to FIG. 3, which is a simplified diagram illustrating the system, including the remotely located handset, that allows services at the called number to be made available via automatically initiated data sessions according to a preferred embodiment of the present invention. The system comprises handset 10 as discussed above, and an application server 20 that handles the services to be provided. The skilled person will be aware that the application server 20, whilst being associated with the called number, need not necessarily be located physically with the called number. Rather it will often be located at the premises of the telephone service provider of the called number. In addition, for some of the embodiments an application reference database (ARDB) 30 is provided. Operation of the system in voice to data session transfer will now be described with respect to FIGS. 4 and 5.

Reference is now made to FIG. 4, which is a simplified flow chart illustrating a procedure for automatically initiating a data session according to one preferred embodiment of the present invention. In stage S40 a subscriber dials the number, as illustrated in FIG. 1. In stage S42 a voice session is initiated.

In stage S44 the application server determines that a data session is required. Typically this is achieved by checking the CLI of the calling party agasint a database of CLIs to see if the calling number is entered in a database of users who have requested the data service. If not then the voice session is resumed S46.

Aside from checking with a database, a number of other options for determining whether the data service is required are possible. In one embodiment a particular service may be automatically provided to any caller to the given number and if there is no response to the attempt to set up a data session then the voice session is resumed. In an alternative embodiment, compatibility of the connecting device may be determined from the caller line identification (CLI) information The CLI is the caller's telephone number, and in one preferred embodiment, if the CLI indicates that the call is being made from a mobile network, then the system identifies the mobile network from the CLI and the caller is assumed to be compatible with the data session. In another embodiment users subscribe to the service and indicate whether their telephones are compatible with a data service. The CLI's of the subscribed users are stored in a database and the database is consulted when a call is made to determine whether the CLI is one of those that is subscribed. If the CLI is found to be subscribed then a data session is provided, otherwise it is not.

While most fixed telephones typically are not compatible, meaning they are unable to provide data sessions, DECT telephones may enable application of the present embodiments over such fixed or wireline telephones. More information regarding DECT technology can be found at http://www.dectweb.com the contents of which are hereby incorporated by reference.

Furthermore CLI information is not always available with the call, for example if the call is made from overseas. In such cases therefore it may be difficult to determine compatibility of the calling device. One option therefore in the absence of a CLI is to attempt to set up a data session regardless. A successfully established data session includes data handshakes and thus if the handshakes do not occur then the voice session may simply be resumed S46.

Preferably, before trying to transfer from the voice to a data session the system plays an informative message to the caller, for example it may play a voice message stating that it is trying to transfer to a data session. If the transfer to a data session fails for any reason then the system preferably plays a voice message indicating that it could not start the data session. As a further option, instead of simply indicating that it is passing to a data session, a voice message could be used to offer the subscriber the choice of moving to the data session if the subscriber so wishes. A key response from the user is then awaited, in accordance with which the system decides whether or not to carry out the session transfer.

In stage S48 a voice cue is sent from the application server 20 to the remote telephony device. Typically the cue is a series of DTMF tones and preferably they include data session address information in the form of a uniform resource locater (URL). Optionally the cue further includes session identification information in the form of a session ID, which identifies the individual device 10. The session ID provides continuity between the voice and data sessions. That is to say, without a session ID the voice and data sessions are not associated at the application server 20 and data is not passed from one to the other. The session ID is merely optional because in many cases it is not necessary to pass data from one session to the other.

In stage S50 a data session is opened. The data session is typically a wireless access protocol (WAP) session. That is, the handset initiates the data session in accordance with the cue received from the application server 20. As indicated, the cue may include data session address information in the form of a uniform resource locater (URL). Depending on the handset, straightforward WWW type web browsing may be supported and another prominent browsing environment that may be supported by the handset is i-mode. Further details regarding I-mode are to be found at http://www.i-mode.com and http:www.palowireless.com/imode/, the contents of both of which are hereby incorporated by reference.

In optional stage S52 the voice session is resumed. Thus in the example given above of the menu of extension numbers, the voice session is resumed once the required extension has been selected. A preferred way of resuming the voice session is by activating a dialing action in the handset. In the case of a WAP session such a dialing action may be initiated by activation of the WTAI command, which is a standard WAP command. Standard WAP commands may be consulted at Wireless Telephony Application Interface Specification WAP-268-WTAI-20010908-a at http://www1.wapforum.org/tech/terms.asp?doc=WAP-268-WTAI-20010908-a.pdf, the contents of which are hereby incorporated by reference. Additional relevant material to standard WAP operation and functionality is available at http://www.wapforum.org/what/technical.htm. Other browsing environments will use other commands as will be recognized by those skilled in the art.

Reference is now made to FIG. 5, which is a simplified flow chart illustrating an alternative procedure for automatically initiating a data session according to another preferred embodiment of the present invention. Stages that are the same as in FIG. 4 are given the same reference numerals and are not described again except as necessary for an understanding of the present embodiment. In FIG. 5 the initial stages of setting up the voice session and selecting the need for a data session are the same as for FIG. 4. However in FIG. 5 the URL is never transferred to the remote device, such as the handset. Instead, in stage S54 the URL, together with the CLI of the calling device, are stored in ARDL database 40. The cue, comprising simply a command to initiate a data session, is then issued in stage S56. In stage 56 the handset preferably enters a pre-programmed default URI (Universal Reference Identifier) which launches a session referencing the server in response to the cue command, and preferably indicating the CLI of the handset. The server then uses the CLI, received from the handset, as an index to look up the database and identify the URL. The URL then indicates the appropriate application for the handset.

It is further noted that the preprogrammed URI may contain CLI information, thus solving the issue of identifying the handset in cases where CLI information is not available to the server through regular network services. The server then initiates a search of database 30 based on its CLI, stage S58. The URL is retrieved in stage S60 and is used to set up the data session as before. Again it is possible to restore the voice session in the same way as discussed with the embodiment of FIG. 4.

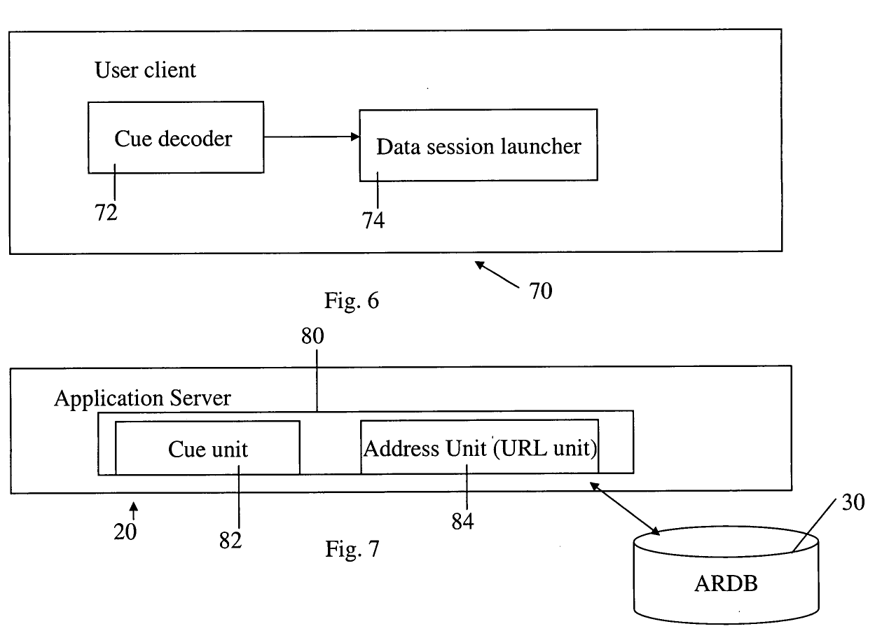

FIG. 6 illustrates a client to be provided at any smart telephone which is able to support data sessions, for carrying out a voice to data session transfer in accordance with a remotely received voice command in accordance with a preferred embodiment of the present invention. The client 70 includes a decoder 72 which decodes the voice cue issued in stages S48 or S56. In the embodiment of FIG. 4 the cue being decoded includes associated data such as the URL and optionally the session ID as explained. A Data session launcher 74 launches an appropriate Internet browsing session, for example a WAP, i-mode, or World Wide Web session, using the associated data, such as the URL, to set up the session. In the embodiment of FIG. 5 no associated data is provided to the Data session launcher 74 and the session is launched by initiating a search for the URL in database 30. The session is then set up at the URL obtained from the database.

FIG. 7 is a simplified diagram illustrating a control apparatus at application server 20 for managing remote initiation of a data session in accordance with a preferred embodiment of the present invention. The control apparatus 80 comprises a cue unit 82 which determines that a data session is needed and issues the necessary command or cue. An address unit 84 generates or otherwise provides associated data such as the URL and optionally the session ID as required. For example in some cases all users might be provided with the same URL, and in other cases a user customized service may be provided, in which case the URL may be individualized for the given user.

Depending on the embodiment the associated data, that is the URL and optional session ID, is either sent with the cue to the handset 10 or is stored in database 30 together with the CLI of the calling party.

It is expected that during the life of this patent many relevant devices and systems will be developed and the scope of the terms herein, particularly of the terms “telephony device”, and “URL”, are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. Apparatus for initiating a data session at a remote communication unit currently connected via a voice session, the apparatus comprising:
a cue unit for sending via said voice session to said remote unit a cue decodable as an instruction to start a data session, and
an address unit for providing data session address information to said data session.

2. Apparatus according to claim 1, wherein said address unit is configured to send said data session address information to said remote communication unit.

3. Apparatus according to claim 2, wherein said address unit is further configured to send session identification information together with said data session address information to said remote communication unit.

4. Apparatus according to claim 2, wherein said address unit is associated with said cue unit and is configured to send said data session address information along with said cue within said voice session.

5. Apparatus according to claim 3, wherein said address unit is associated with said cue unit and is configured to send said data session address information and said session identification information along with said cue within said voice session.

6. Apparatus according to claim 1, wherein said address unit is configured to enter said data session address information along with caller identification information in a database.

7. Apparatus according to claim 6, wherein said cue is decodable at said remote communication apparatus to access said database, said caller identification information allowing said data session address information to be retrieved from said database to define said data session.

8. Apparatus according to claim 1, further configured to issue a command from said data session to restart said voice session.

9. Apparatus according to claim 8, wherein said command is a dialing action initiator.

10. Apparatus according to claim 1, wherein said data session comprises a menu-based user interface.

11. Apparatus according to claim 1, wherein said data session comprises a graphically-based user interface.

12. Apparatus according to claim 1, wherein said voice cue comprises a sequence of DTMF tones.

13. Apparatus according to claim 1, wherein said cue unit is operable to send said voice cue to all connecting remote communication devices.

14. Apparatus according to claim 1, wherein said cue unit is associated with a database of communication device identity data to send said voice cue only to a subset of remote communication devices indicated by said database.

15. Apparatus according to claim 1, wherein said cue unit is configured to send said voice cue only if said data session is indicated as being required by said remote communication device.

16. Apparatus according to claim 1, wherein said data session comprises one of a group of applications comprising visual directory assistance, visual shopping and visual voicemail deposit.

17. A client for a smart telephony device capable of supporting a data session, the client comprising:
a decoder for decoding a received voice command to transfer to a data session, and
a data session launcher, associated with said decoder, for launching a data session at said smart telephony device in response to the received voice command.

18. The client of claim 17, wherein the voice command includes encoded data session address information and said decoder is configured to decode the data session address information from said command and for providing the decoded data session address information to said data session launcher.

19. The client of claim 17, wherein said data session launcher is configured to automatically consult a database associated with said received voice session command to associate data session address information with said data session.

20. A method of launching a data session at a remote telephony device that has connected using a voice session, the method comprising:
issuing a data session launch command via said voice session to said remote telephony device, and
issuing data session address information for use in association with a data session launched in consequence of said command.

21. The method of claim 20, further comprising sending said data session address information to said remote telephony device together with said command as part of said voice session.

22. The method of claim 21, further comprising sending session identification information together with said data session address information to said remote telephony device.

23. The method of claim 20, further comprising placing said data session address information in a database and indexing said data session address information with caller identification information.

24. The method of claim 23, further comprising accessing said database using said caller identification information of said remote telephony device to obtain said data session address information.

25. The method of claim 24, further comprising initiating a data session with said obtained data session address information.

26. The method of claim 20, wherein said data session comprises a menu-based user interface.

27. The method of claim 20, wherein said data session comprises a graphically-based user interface.

28. The method of claim 20, wherein said data session comprises a user selection option available to a user at said remote communication unit to return said data session to a voice session.

29. The method of claim 28, wherein said user selection option comprises a command for activating a dialing action at said remote communication unit.

30. The method of claim 20, wherein said data session launch command is a voice cue comprising a sequence of DTMF tones.

31. The method of claim 20, comprising sending said data session launch command to all connecting remote communication devices.

32. The method of claim 20, comprising using a database of communication device identity data to send said data session launch command only to a subset of remote communication devices indicated by said database.

33. The method of claim 20, comprising sending said data session launch command only if said data session is indicated as being required by said remote communication device.

34. The method of claim 20, wherein said data session operates one of a group of applications comprising visual directory assistance, visual shopping and visual voicemail deposit.
